(19) United States
(12) Patent Application Publication
(10) Pub. No.: US 2015/0040523 A1
(43) Pub. Date: Feb. 12, 2015

(54) SADDLE PAD

(71) Applicant: Badazz Saddlepads, Inc., Onarga, IL (US)

(72) Inventor: Tamara J. Seggebruch, Onarga, IL (US)

(73) Assignee: Badazz Saddlepads, Inc., Onarga, IL (US)

(21) Appl. No.: 13/962,427

(22) Filed: Aug. 8, 2013

(51) Int. Cl. B68C 1/12

(52) U.S. Cl. CPC B68C 1/12
USPC 54/66

(57) ABSTRACT

A saddle pad comprises an elongate insert having a pocket which has a size and shape which differs from the size and shape of the insert, and a flexible polymer gel pad of substantially the same size and shape as the pocket is positioned in the pocket. Plural shim pockets are also positioned on the insert pocket and shims may be positioned in some or all of the shim pockets to increase the thickness of the insert to reduce bridging of the saddle. A flexible shell having a pair of pockets of substantially the same size and shape as the inserts is provided and the inserts are positioned in the shell pockets through an opening in the end of each of the shell pockets. The saddle pad also includes an air channel which separates the shell pockets and which ventilates the spine of the horse.

### BACKGROUND AND SUMMARY OF THE INVENTION

The present invention relates to a saddle pad, and more particularly to a saddle pad for placing on the back of an animal beneath a saddle.

A wide variety of saddle pads have been employed over the years to protect the back of the animal against discomfort and injury from the saddle and the weight of the rider. Such prior saddle pads have employed cushioning materials of various kinds for this purpose. For example, such cushioning materials recently have included impact polymer gels covered with various flexible fabrics or materials. However, such gel cushioning materials have generally been located within most if not all of the area of the saddle pads and, therefore, have not optimized their effectiveness for their intended purpose and the saddle pads are heavy due to the quantity of gel. Moreover, prior saddle pads have not generally taken into account the differences in the shapes or irregularities in the backs of individual animals, and have not uniformly supported all of the underside areas of the saddle on the back of the animal.

The saddle pad of the present invention has the purpose of overcoming one or more of these shortcomings of the prior saddle pads. The saddle pad of the present invention only provides cushioning where it is needed thereby optimizing the effectiveness of the pad and minimizing its weight. The saddle pad of the invention also provides only minimal cushioning at the shoulder of the animal where cushioning of the saddle is not needed. Moreover, in the saddle pad of the invention, the pad may be selectively shimmed to provide uniform cushioning and support of the underside of the saddle over its length and avoid bridging of the saddle on the back of the animal between the ends of the saddle. The saddle pad of the present invention also vents and protects the spinal column of the animal when the rider is in the saddle. Significantly, the saddle pad of the invention readily accommodates differences in shapes and irregularities in the back of the animal because it is possible to customize each of the saddle pads to the back configuration of the particular animal with which the pad is to be used. Moreover, the saddle pad of the invention includes a flexible shell which may be separated from other components of the saddle pad for washing or replacement.

In one principal aspect of the present invention, a saddle pad comprises an elongate insert formed of a pair of flexible sheets of material to define an upper face and a lower face of a given size and shape, and an elongate pocket between the faces and extending along and adjacent to a longitudinal edge of the insert. The pocket has a size and shape which differs from the given size of the sheets and which is shorter and narrower than the given size of the sheets. The flexible sheets of material are fastened together along their edges to define the given size of the insert and are fixed together at the pocket to define the size and the shape of the pocket. A flexible polymer gel pad of substantially the same size and shape as the pocket is positioned in the pocket.

In another principal aspect of the present invention, the saddle pad includes a plurality of shim pockets positioned on the insert pocket in side by side relationship to each other along and adjacent to the longitudinal edge of the insert and on one of the faces of the insert, and at least one shim of flexible material is positionable in at least one of the shim pockets to increase the thickness of the insert at the shim.

In still another principal aspect of the present invention, at least some of the shim pockets are of different sizes and shapes from each other.

In still another principal aspect of the present invention, the saddle pad includes a plurality of the shims and at least some of the shims are of different sizes and shapes from each other.

In still another principal aspect of the present invention, the elongate insert pocket and the flexible polymer gel pad are shorter than the insert to define a space on the insert between its end and an end of the insert pocket which is free of the flexible polymer gel pad to accommodate the shoulder of an animal upon which the saddle pad is to be used.

In still another principal aspect of the present invention, the saddle pad includes a flexible shell having a pair of pockets of substantially the same size and shape as the given size and shape of the insert, and the shell pockets are positionable over the ribs of an animal upon which the saddle pad is to be used. An opening is in an end of each of the shell pockets, and the saddle pad includes a pair of the inserts one of which is positioned in each of the shell pockets through the openings.

In still another principal aspect of the present invention, the saddle pad includes a fastener adjacent each of the shell pocket openings to open and close the openings and permit the insertion or removal of the inserts into or from the shell pockets.

In still another principal aspect of the present invention, the saddle pad includes an air channel separating the shell pockets from each other over the length of the shell, the air channel being positionable over the spine of an animal upon which the saddle pad is to be used when the flexible polymer gel pads in the inserts are positioned over the ribs of the animal.

In still another principal aspect of the present invention, the saddle pad includes a notch in the shell and air channel at their forward ends.

These and other objects, features and advantages of the present invention will become readily understood upon a consideration of the following detailed description.

### BRIEF DESCRIPTION OF THE DRAWINGS

In the course of this description, the drawings will frequently be referred to in which:

FIG. 1 is an exploded perspective view of a horse, a preferred saddle pad of the invention and a saddle to be mounted upon the pad and the horse;

FIG. 2 is an exploded side elevational view of a saddle pad insert and polymer gel pad in accordance with the principles of the present invention;

FIG. 2A is a top plan view of the saddle pad insert of the present invention as viewed substantially along line 2A-2A of FIG. 2;

FIG. 3 is an exploded side elevational view of the saddle pad insert and shims in accordance with the principles of the present invention;

FIG. 4A is a side elevational view of the saddle pad insert of the present invention with a saddle tree bar form superimposed thereon and showing bridging of the saddle tree form prior to employment of the shims of the present invention;

FIG. 4B is a side elevational view of the saddle pad insert and saddle tree bar form as seen in FIG. 4A, but in which the shims have been employed;

FIG. 5 is a perspective view of the saddle pad shell of the present invention into which the saddle pad inserts have been inserted;

FIG. 6 is a bottom perspective view of the saddle pad shell as seen in FIG. 5;

FIG. 7 is a plan view of the horse with the saddle pad of the invention thereon, and with a saddle tree bar form in dashed lines superimposed on the saddle pad; and

FIG. 8 is a rear view of the horse with the saddle pad thereon.

### DESCRIPTION OF THE PREFERRED EMBODIMENT

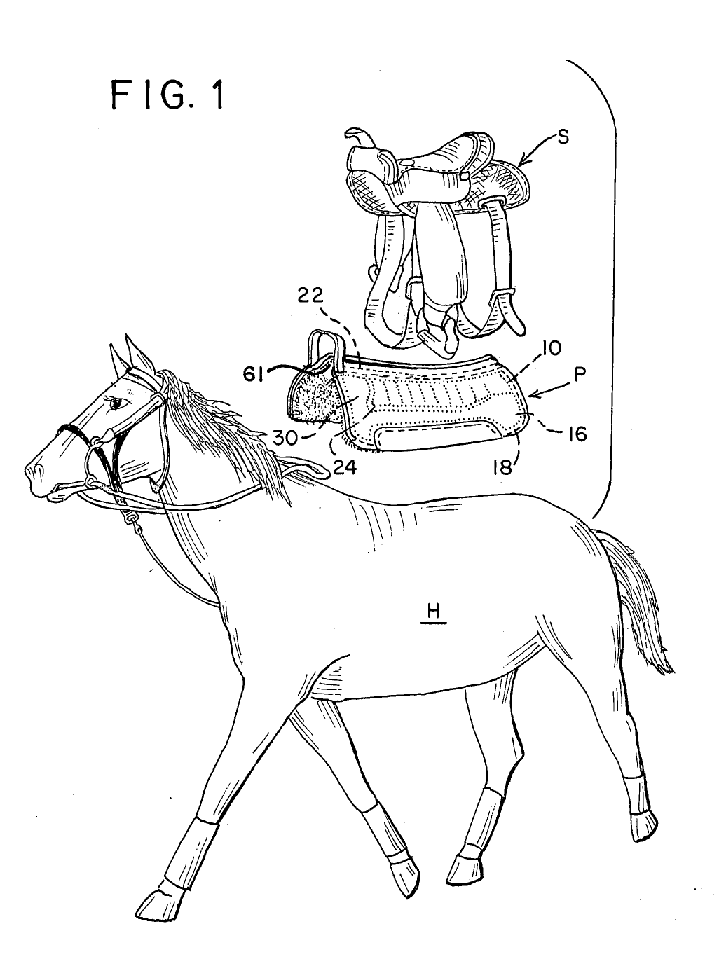

In FIG. 1 an exploded view of an animal to be saddled, such as a horse H, with a preferred embodiment of saddle pad P and a saddle S.

The saddle pad includes a pair of elongate inserts 10 and 12 as seen in FIGS. 1-5. The insert on the left side of the horse is insert 10 and the right side insert is insert 12. Both inserts 10 and 12 are of the same general construction and are generally mirror images of each other. Accordingly, only the left side insert 10 will be described in detail to follow.

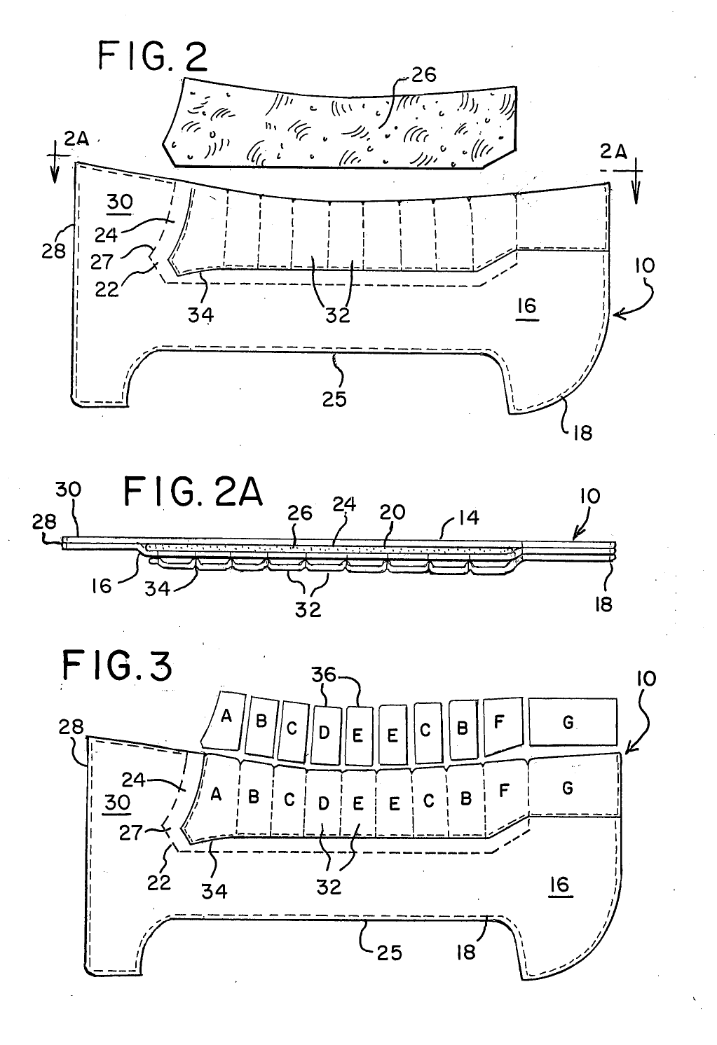

Referring particularly to FIGS. 2, 2A and 3, the insert 10 comprises a pair of generally flexible fabric sheets of material 14 and 16, such as wool felt. The sheets of material 14 and 16 are of substantially the same size and shape and are superimposed upon each other as best seen in FIG. 2A to define an upper face and a lower face which are also of substantially the same size and shape. The sheets of material 14 and 16 are then stitched together at 18 about their perimeter with the exception of part of the upper longitudinal edge 20 as seen in FIGS. 2 and 2A. The sheets 14 and 16 are also stitched together at 22 to define a pocket 24 of a different smaller size and shape than the sheets of material 14 and 16.

The sheets of material 14 and 16 are also preferably notched at 25 to reduce the weight of the insert, to facilitate contact of the rider's legs with the side of the horse and to facilitate cinching of the saddle on the horse.

A flexible polymer gel pad 26 is cut and formed to be of substantially the same size and shape as the pocket 24 and the pad is inserted into the pocket. Once it is positioned in the pocket, the longitudinal edge 20 of the insert 10 may then also be stitched together to close the pocket with the gel pad 26 therein. The flexible gel pad is preferably a viscoelastic polymer of about ⅜ inch thickness, about 20 inches in length and about 6 inches in width. A suitable gel polymer is available from Akton Products, Inc. Bakerstown, Md. as its EQ202438 pad.

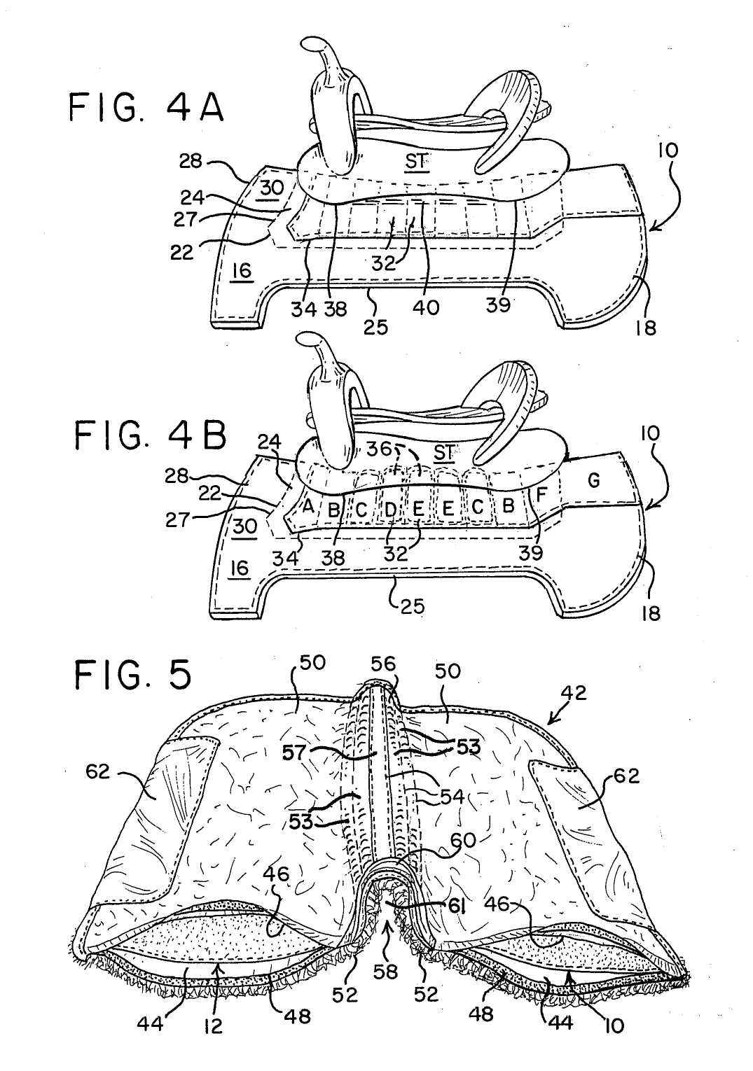

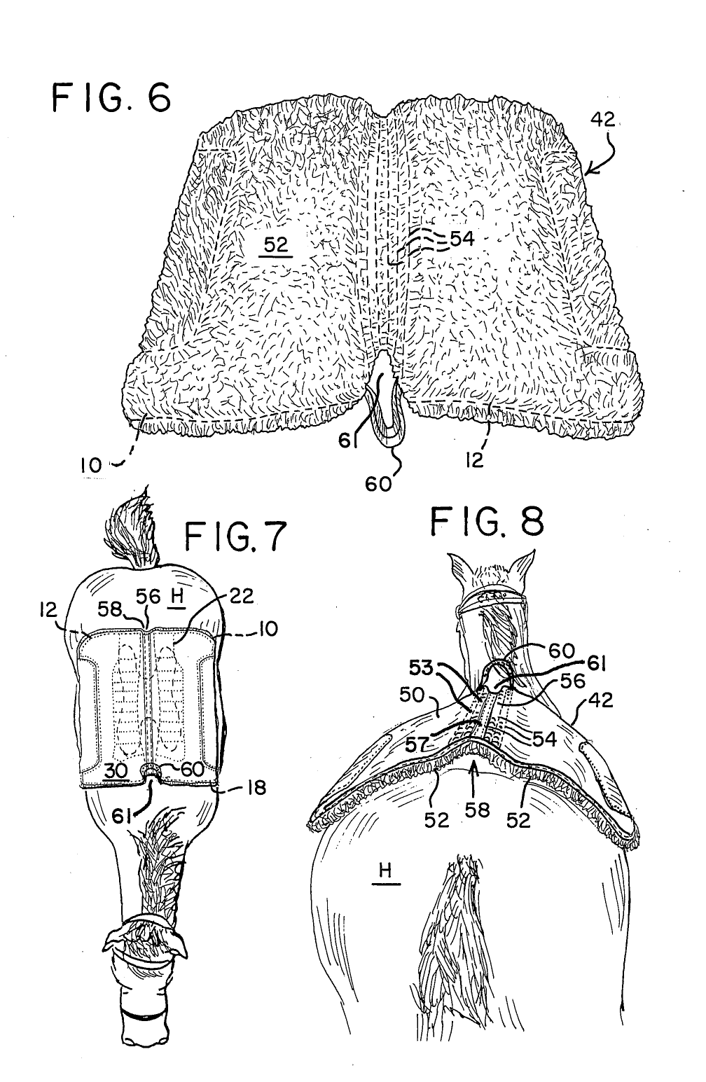

It should be noted that in the preferred embodiment of saddle pad of the present invention, the forward end 27 of the pocket 24 and polymer gel pad 26 toward the head of the horse are spaced from the forward end 28 of the insert 10 to provide a portion 30 which is free of the gel pad. The portion 30 will overlie the shoulder of the horse when the pad has been positioned on the horse. This portion 30 need not include the gel because it does not underlay the forward end of the saddle S or the saddle tree ST as seen in FIGS. 4A and 4B. Accordingly, the weight of the saddle pad is reduced and the comfort to the horse is improved at the shoulder of the horse.

With particular reference to FIGS. 3, 4A and 4B, a plurality of shim pockets 32 of preferably the same material as the sheets of material 14 and 16 of the insert 10 are stitched at 34 to the upper face of the upper sheet 16 of the material and in overlying relationship to the pocket 24 and polymer gel pad 26. Some of the shim pockets 32, e.g. B, C and E, may be of the same size and shape, and some of the shim pockets 32 may be of different sizes and shapes, e.g. A, F, and G.

Shims 36 are also provided which preferably have comparable sizes and shapes to the shim pockets 32 into which they are to be received. The shims 36 may be also formed of the same material, such as wool felt, of which the insert 10 is formed.

Referring particularly to FIGS. 4A and 4B, after the polymer gel pad 26 has been positioned in the insert pocket 24, the insert 10 is custom fitted to the shape of the horse and the size and shape of the saddle to be placed on the horse. To do this, the insert 10 is positioned on the horse's back with the polymer gel pad 26 over the ribs of the horse, and a saddle tree ST of which the saddle S is to be formed and which has the shape of the saddle S is positioned on the insert as shown in FIGS. 4A and 4B. The saddle tree ST will typically contact the insert at its ends 38 and 39 and will bridge and be elevated above the insert at its center 40 as seen in FIG. 4A.

In order to minimize the spacing of the saddle tree ST and such bridging and provide relatively continuous contact of the saddle over its length with the insert 10, shims 36 are selectively positioned in the pockets 32, such as shims C, D, E and C as seen in FIG. 4B, to increase the thickness of the insert 10 as needed. This will optimize the weight distribution of the saddle and rider on the back of the horse.

As previously mentioned, the description above of the insert 10 is of the insert to be positioned on the left side of the horse. The construction and assembly of the insert 12 to be positioned on the right side of the horse is substantially identical to the construction and assembly previously described because the inserts are essentially a mirror image of each other.

In order to complete the preferred embodiment of the saddle pad according to the principles of the invention, a flexible shell 42 is provided having pockets 44 as seen in FIG. 5. The pockets 44 are preferably substantially the same size and shape as the inserts 10 and 12. The pockets 44 have an opening 46 at one end to permit the inserts 10 and 12 to be inserted through the opening into the respective pockets 44 or removed from the pockets as desired. Thus, the inserts 10 and 12 may be removed from the pockets 44 to permit replacement of the shell 42 or washing of the shell in a washing machine or other laundry device as desired.

Each of the openings 46 is also preferably provided with a fastener 48 of some sort, such as Velcro, to permit the openings to be easily opened and closed.

The upper face of the shell 42 is preferably formed of a textile fabric 50. The lower face of the shell which is to directly contact the back of the horse is preferably formed of a comfortable material, such as a wool fleece 52.

In the preferred embodiment of the present invention, the shell 42 between the pockets 44 has two strips of padding 53 on each side which are stitched at 54 beneath the fabric 50 as seen in FIG. 5 to provide a permanent hump 56 which stands up along the spine of the horse when the flexible polymer gel pads 26 and pockets 24 overlie the ribs of the horse. The strips of padding 53 may also be formed of wool felt. A strip 59 of textile is also preferably stitched along the top of the hump 56, but there is no padding beneath the strip 57. This permanent hump 56 thereby results in an air channel 58 along the horse's spine as seen in FIGS. 7 and 8 to permit ventilation on the back of the horse during riding.

A loop 60 is also preferably provided at the forward head end of the shell 42 to facilitate fore and aft positioning of the saddle pad on the horse.

The hump 56 and air channel 58 are preferably cut back somewhat at 61 at the location of the loop 60. This facilitates the start of the airflow in the channel 58 and the visual positioning of the saddle pad on the back of the horse.

A loop 60 is also preferably provided at the head end of the shell 42 to facilitate fore and aft positioning of the saddle pad on the horse.

An elongate sheet 62 of material, such as a faux leather, is also preferably stitched to the shell 42 in overlying relation to the notch 25 in the inserts 10 and 12 to protect the horse during cinching.

Although the saddle pad of the present invention is described as a pad for a horse saddle, it will be appreciated that the pad of the invention may be employed with saddles designed for other animals.

From the foregoing it will be appreciated that the saddle pad of the present invention only provides increased cushioning where it is needed thereby optimizing the effectiveness of the pad and minimizing its weight. It will also be appreciated that the saddle pad of the invention also provides only minimal cushioning at the shoulder of the animal where cushioning of the saddle is not needed.

In the saddle pad of the invention, the pad may be selectively shimmed to provide uniform cushioning of the underside of the saddle over its length and avoid bridging of the saddle on the back of the horse between the ends of the saddle.

It will also be appreciated that the saddle pad of the present invention vents and protects the spinal column of the horse when the rider is in the saddle. Moreover, the saddle pad readily accommodates differences in shapes and irregularities on the back of different horses because it is possible to customize each saddle pad to the back configuration of the particular horse with which the pad is to be used. And it will be appreciated that the flexible shell of the saddle pad of the invention may be separated from other components of the saddle pad for washing or replacement.

It also will be appreciated that the preferred embodiment of the present invention which has been described is merely illustrative of only a few of the principles of the present invention. Numerous modifications may be made by those skilled in the art without departing from the true spirit and scope of the present invention.

1. A saddle pad, comprising:
an elongate insert formed of a pair of flexible sheets of material to define an upper face and a lower face of a given size and shape;
an elongate pocket between said faces and extending along and adjacent to a longitudinal edge of said insert, said pocket having a size which differs from said given size and which is shorter and narrower than said given size of said sheets;
said flexible sheets of material being fastened together along their edges to define said given size of said insert and being fixed together at said pocket to define the size and shape of said pocket; and
a flexible polymer gel pad of substantially the same size and shape as said pocket and positioned in said pocket.

2. The saddle pad of claim 1, including a plurality of shim pockets positioned on said insert pocket in side by side relationship to each other along and adjacent to said longitudinal edge of said insert and on one of said faces of said insert, and at least one shim of flexible material positionable in at least one of said shim pockets to increase the thickness of said insert at said shim.

3. The saddle pad of claim 2, wherein at least some of said shim pockets are of different sizes and shapes from each other.

4. The saddle pad of claim 2, including a plurality of said shims and wherein at least some of said shims are of different sizes and shapes from each other.

5. The saddle pad of claim 1, wherein said elongate insert pocket and said flexible polymer gel pad are shorter than said insert to define a space on said insert between its end and an end of said insert pocket which is free of said flexible polymer gel pad to accommodate the shoulder of an animal upon which the saddle pad is to be used.

6. The saddle pad of claim 2, wherein said elongate insert pocket and said flexible polymer gel pad are shorter than said insert to define a space on said insert between its end and an end of said insert pocket to accommodate the shoulder of an animal upon which the saddle pad is to be used.

7. The saddle pad of claim 1, including a flexible shell having a pair of pockets of substantially the same size and shape as said given size and shape of said insert, said shell pockets being positionable over the ribs of an animal upon which the saddle pad is to be used;
an opening in an end of each of said shell pockets; and
a pair of said inserts one of which is positioned in each of said shell pockets through said openings.

8. The saddle pad of claim 7, including a fastener adjacent each of said shell pocket openings to open and close said openings and permit the insertion or removal of said inserts into or from said shell pockets.

9. The saddle pad of claim 7, including an air channel separating said shell pockets from each other over the length of said shell, said air channel being positionable over the spine of an animal upon which the saddle pad is to be used when said flexible polymer gel pads in said inserts are positioned over the ribs of the animal.

10. The saddle pad of claim 9, including a notch in said shell and air channel at their forward ends.

11. The saddle pad of claim 2, including a flexible shell having a pair of pockets of substantially the same size and shape as said given size and shape of said insert, said shell pockets being positionable over the ribs of an animal upon which the saddle pad is to be used;
an opening in an end of each of said shell pockets; and
a pair of said inserts one of which is positioned in each of said shell pockets through said openings.

12. The saddle pad of claim 8, including a fastener adjacent each of said shell pocket openings to open and close said openings and permit the insertion or removal of said inserts into or from said shell pockets.

13. The saddle pad of claim 11, including an air channel separating said shell pockets from each other over the length of said shell, said air channel being positionable over the spine of an animal upon which the saddle pad is to be used when said flexible polymer gel pads in said inserts are positioned over the ribs of the animal.

14. The saddle pad of claim 13, including a notch in said shell and air channel at their forward ends.

15. The saddle pad of claim 5, including a flexible shell having a pair of pockets of substantially the same size and shape as said given size and shape of said insert, said shell pockets being positionable over the ribs of an animal upon which the saddle pad is to be used;
an opening in an end of each of said shell pockets; and
a pair of said inserts one of which is positioned in each of said shell pockets through said openings.

16. The saddle pad of claim 15, including a fastener adjacent each of said shell pocket openings to open and close said openings and permit the insertion or removal of said inserts into or from said shell pockets.

17. The saddle pad of claim 15, including an air channel separating said shell pockets from each other over the length of said shell, said air channel being positionable over the spine of an animal upon which the saddle pad is to be used when said flexible polymer gel pads in said inserts are positioned over the ribs of the animal.

18. The saddle pad of claim 17, including a notch in said shell and air channel at their forward ends.

19. The saddle pad of claim 6, including a flexible shell having a pair of pockets of substantially the same size and shape as said given size and shape of said insert, said shell pockets being positionable over the ribs of an animal upon which the saddle pad is to be used;
an opening in an end of each of said shell pockets; and
a pair of said inserts one of which is positioned in each of said shell pockets through said openings.

20. The saddle pad of claim 19, including a fastener adjacent each of said shell pocket openings to open and close said openings and permit the insertion or removal of said inserts into or from said shell pockets.

21. The saddle pad of claim 20, including a notch in said shell and air channel at their forward ends.

22. The saddle pad of claim 19, including an air channel separating said shell pockets from each other over the length of said shell, said air channel being positionable over the spine of an animal upon which the saddle pad is to be used when said flexible polymer gel pads in said inserts are positioned over the ribs of the animal.

23. The saddle pad of claim 9, including a notch in said shell and air channel at their forward ends.
